(19) United States
(12) Patent Application Publication
(10) Pub. No.: US 2015/0168573 A1
(43) Pub. Date: Jun. 18, 2015

(54) GEOLOGIC QUALITY FACTOR INVERSION METHOD

(71) Applicants: CHINA NATIONAL PETROLEUM CORPORATION, Beijing (CN); BGP INC., CHINA NATIONAL PETROLEUM CORPORATION, Zhuozhou, Hebei (CN)

(72) Inventors: Gulan Zhang, Zhuozhou (CN); Ximing Wang, Zhuozhou (CN); Qinghong Zhang, Zhuozhou (CN); Yanpeng Li, Zhuozhou (CN); Jixin Peng, Zhuozhou (CN); Yufeng Zhao, Zhuozhou (CN); Jiaojun Rong, Zhuozhou (CN); Keen Li, Zhuozhou (CN); Qihu Jin, Zhuozhou (CN); Xiaoling Guo, Zhuozhou (CN)

(21) Appl. No.: 14/394,100

(22) PCT Filed: Dec. 11, 2012
(86) PCT No.: PCT/CN2012/001686

§ 371 Date: Feb. 6, 2015

(30) Foreign Application Priority Data
Apr. 13, 2012 (CN) 201210109416.8

(51) Int. Cl. G01V 1/30

(52) U.S. Cl. CPC G01V 1/30; G01V 2210/60

(57) ABSTRACT

Provided is a method for performing layer Q factor inversion by using an amplitude spectrum attribute of a down going wave of vertical seismic profile data in a geophysical exploration data processing technology. In the method, first an F-K (frequency-wave number) method is used to perform wave field separation on VSP original data, so as to obtain a down going wave; a down going wavelet and a monitoring wavelet are selected to undergone Fourier transform to obtain an amplitude spectrum, polynomial fitting is performed on the amplitude spectrum to obtain an equivalent Q, and a formula between the equivalent Q and a layer Q is used to perform inversion, so as to obtain the layer Q. The method has a strong capability of resisting random disturbance, and is capable of removing a difference of triggering wavelet. The algorithm is simple and can greatly save workload; moreover, the layer Q value obtained through inversion has a desirable stability and high precision.

### TECHNICAL FIELD

The present invention relates to a seismic exploration data processing technology, which is a strata quality factor inversion method by using an amplitude spectrum attribute of a down going wave of vertical seismic profile (VSP) data, with a desirable stability.

### BACKGROUND

With an increase in a demand of seismic exploration precision, seismic data with high resolution is needed to describe in detail oil and gas reservoir, but attenuation due to strata absorption is a major factor for affecting the resolution of the seismic data. The attenuation due to the strata absorption mainly expresses as an amplitude attenuation, a phase distortion, and a frequency reduction (moreover, the attenuation in high-frequency portion is faster than that in low-frequency portion, and the attenuation in shallow layer is faster than that in deep layer) during propagation of seismic wave, which seriously reduces the resolution of the seismic data. A strata quality factor (Q factor) value is estimated accurately, and then effective inverse Q filtering compensation is performed on a prestack or post-stack seismic record, which may make waveforms of reflection waves in shallow, medium and deep layers of seismic profile substantially consistent, may make high-frequency portion of the medium and deep layers strengthen, and in turn may make the frequency spectrum widen, so as to recovery original seismic waveform and eliminate effects of a wavelet time varying, thereby meeting a hypothesis required for deconvolution and wavelet estimation that the wavelet is time-invariant. Thus, the seismic profile quality can be effectively improved so as to facilitate the processing and explanation of the seismic data.

During zero-offset VSP (vertical seismic profile) data acquisition, a shot point is very close to a well head, so that down going direct waves received in different depths have the same propagation path. Therefore, the down going direct waves in the seismic records with different depths can be directly used for inverting the strata quality factor (Q factor), and performing the inverse Q filtering, so as to increase the resolution of the VSP data and drive the surface-seismic processing to increase the resolution. Therefore, how to perform precise Q extraction by using the zero-offset VSP data has great important practical application value.

The strata quality factor Q inversion method is mainly to apply logarithm spectral ratio method, centroid and peak frequency downshift method, combination of scanning technology and time-frequency analysis method, multiple window spectral analysis method on the amplitude spectrum of the seismic wavelet. Among these, it is assumed in the centroid and peak frequency downshift method that the amplitude spectrum of the seismic wave can be represented by Gaussian spectrum; and it is assumed in the time-frequency analysis method that the seismic wavelet has a zero phase.

Mathneey and Nowack proposed an instantaneous frequency matching method, which is to use an iteration process to modify a causal attenuation operator, such that weighted instantaneous frequencies by the operator acting on envelope peak after reference pulse and on envelope peak of a target pulse are closest, thereby inversing quality factor of the medium. Adopting this method, Mathneey and Nowack estimated the attenuation of the seismic data on earth crust diffraction. Dasios et al. estimated the attenuation of a full-wave train acoustic logging record by adopting an instantaneous frequency matching method. Such method overcomes some shortcomings of the logarithmic spectrum ratio method, for example, it is not necessary to select a variable frequency band range and so on. However, this method needs to use Hilbert transform method so as to calculate the instantaneous frequency, and to use complicated iteration process so as to match the instantaneous frequency. As is well-known, the Hilbert transform is sensitive to noise; therefore, the use of the instantaneous frequency matching method in a seismic signal with noise is limited. Barnes assumed that a seismic source wavelet is an ideal band-pass wavelet, and gave a relationship between the instantaneous frequency and the Q value as well as the transmission time, but the actual seismic source wavelet is greatly different from the ideal band-pass wavelet.

All the methods above are hardly applied to the practical data, and do not disclose how to use the down going wave of the VSP data. Moreover, in all the methods above, the inverted Q value and a velocity value of the strata hardly have correspondence, and it is impossible to estimate the reasonability of the inverted Q value. In addition, none of the methods above considers an excitation wavelet difference caused by an excitation environment during collection, which hardly has applicability and generalization performance, and certainly will influence the stability of the quality factor Q.

### SUMMARY

An object of the present invention is to provide a strata quality factor inversion method by using an amplitude spectrum attribute of a down going wave of vertical seismic profile (VSP) data, with a desirable stability.

The present invention includes the specific steps:

1) shocking a surface seismic source, receiving vertical seismic profile data by geophone in underground, and receiving, by a geophone near the seismic source, a monitoring wavelet signal corresponding to each trace of vertical seismic profile record;

2) picking up a first arrival 1 of each trace of the vertical seismic profile record, and a first arrival 2 of the monitoring wavelet signal corresponding to each trace of the vertical seismic profile record;

3) flattening down going waves by subtracting the first arrival time 1 of each trace of the vertical seismic profile record from time of each sampling point of the said trace, so as to obtain a first wave field;

4) obtaining a frequency-wave number (F-K) spectrum of the first wave field by firstly applying Fourier transform to the first wave field in time direction so as to transform into frequency domain, thereby obtaining an amplitude spectrum of all of the vertical seismic profile record, and then applying Fourier transform to the amplitude spectrum in a direction of a trace number so as to transform into a wave number domain;

5) multiplying the frequency-wave number (F-K) spectrum corresponding to up going wave in the frequency-wave number (F-K) spectrum obtained in step (4) by zero; then performing an inverse Fourier transform in a direction of wave number to obtain an amplitude spectrum; applying an inverse Fourier transform in the frequency direction to the obtained amplitude spectrum so as to obtain a second wave filed in the time domain;

6) applying Fourier transform to signal in a time window starting backwards from a first sampling point in each trace of the down going wave in the second wave field, so as to obtain a first amplitude spectrum on every frequency; and dividing the amplitude spectrum corresponding to every frequency by a square of a value of the corresponding frequency so as to obtain a second amplitude spectrum in an exponential form;

7) obtaining the second amplitude spectrum of every frequency in the exponential form in each trace of the down going wave by repeating the step 6);

8) obtaining first and second order coefficients corresponding to a trace of down going wavelet by taking a natural logarithm of the second amplitude spectrum of the trace obtained in the step 7) and then performing quadratic function fitting related to frequency by using a least square method;

9) obtaining the first and second order coefficients corresponding to each trace of the down going wavelet in the vertical seismic profile record by repeating the step 8);

10) picking up the first arrival 2 of the monitoring wavelet recorded in the step 1), obtaining a third amplitude spectrum of the monitoring wavelet on each frequency by applying Fourier transform to the monitoring wavelet signal corresponding to each trace of the vertical seismic profile record inside a time window starting backwards from the first arrival 2 of the monitoring wavelet signal; and obtaining a fourth amplitude spectrum of each trace of the monitoring wavelet in the exponential form by dividing the square of value of every frequency to the amplitude spectrum corresponding to the corresponding frequency;

11) obtaining first and second order coefficients of the frequency spectrum of a trace of the monitoring wavelet by taking a natural logarithm of the fourth amplitude spectrum obtained in the step 10) and then performing quadratic function fitting related to frequency by using the least square method;

12) obtaining the first and second coefficients corresponding to the monitoring wavelet corresponding to each trace of the vertical seismic profile record by repeating step 11);

13) solving, for each trace of the vertical seismic profile record, an average value between the second order coefficients of the trace and the second order coefficient of the corresponding monitoring wavelet obtained in step 12);

14) obtaining first and second coefficients by taking a natural logarithm of the second amplitude spectrum obtained in the step 7), subtracting a product of the average value of the second order coefficients of the seismic trace obtained in the step 13) and the square of the frequency, and then performing quadratic function fitting related to frequency by using the square method;

15) obtaining a first equivalent Q (strata quality factor) value by dividing the first order coefficient of each trace of the vertical seismic profile obtained in the step 14) to the first arrival time 1 of the trace;

16) obtaining the first equivalent strata quality factor of each trace of the vertical seismic profile record by repeating the step 15), and obtain a second equivalent Q (strata quality factor) value by performing statistic smoothing on the first equivalent strata quality factors of all traces of the vertical seismic profile record;

17) obtaining an absorption coefficient of each trace of the vertical seismic profile record by dividing the second equivalent Q (strata quality factor) value corresponding to the trace of the record to the first arrival time 1 of the trace;

18) obtaining the interval Q (strata quality factor) value corresponding to a trace of the vertical seismic profile record by dividing a difference value between the absorption coefficients of adjacent traces of the vertical seismic profile record to a difference value between the first arrival 1 of the adjacent traces;

19) repeating the step 18), until the interval Q (strata quality factor) value corresponding to each trace of the vertical seismic profile record are inversed.

### BRIEF DESCRIPTION OF THE DRAWINGS

FIG. 1 is a schematic diagram of the down going wave;

FIG. 2 is a schematic diagram of a cut-out down going wave;

FIG. 3 is an amplitude spectrum of the cut-out down going wave;

FIG. 4 is a layer Q value obtained through the inversion according to the present invention.

### DETAILED DESCRIPTION OF THE EMBODIMENTS

Hereinafter, a detail of the present invention will be described.

The present invention provides a strata quality factor inversion method by using an amplitude spectrum attribute of a down going wave of vertical seismic profile (VSP) data, with a desirable stability. The specific implementation steps are as follows:

1) shocking a surface seismic source, receiving vertical seismic profile data by geophone in underground, and receiving, by a geophone near the seismic source, a monitoring wavelet signal corresponding to each trace of vertical seismic profile record;

2) picking up a first arrival 1 of each trace of the vertical seismic profile record, and a first arrival 2 of the monitoring wavelet signal corresponding to each trace of the vertical seismic profile record;

3) flattening down going waves by subtracting the first arrival time 1 of each trace of the vertical seismic profile record from time of each sampling point of the said trace, so as to obtain a first wave field;

4) obtaining a frequency-wave number (F-K) spectrum of the first wave field by firstly applying Fourier transform to the first wave field in time direction so as to transform into frequency domain, thereby obtaining an amplitude spectrum of all of the vertical seismic profile record, and then applying Fourier transform to the amplitude spectrum in a direction of a trace number so as to transform into a wave number domain;

5) multiplying the frequency-wave number (F-K) spectrum corresponding to up going wave in the frequency-wave number (F-K) spectrum obtained in step (4) by zero; then performing an inverse Fourier transform in a direction of wave number to obtain an amplitude spectrum; applying an inverse Fourier transform in the frequency direction to the obtained amplitude spectrum so as to obtain a second wave filed in the time domain;

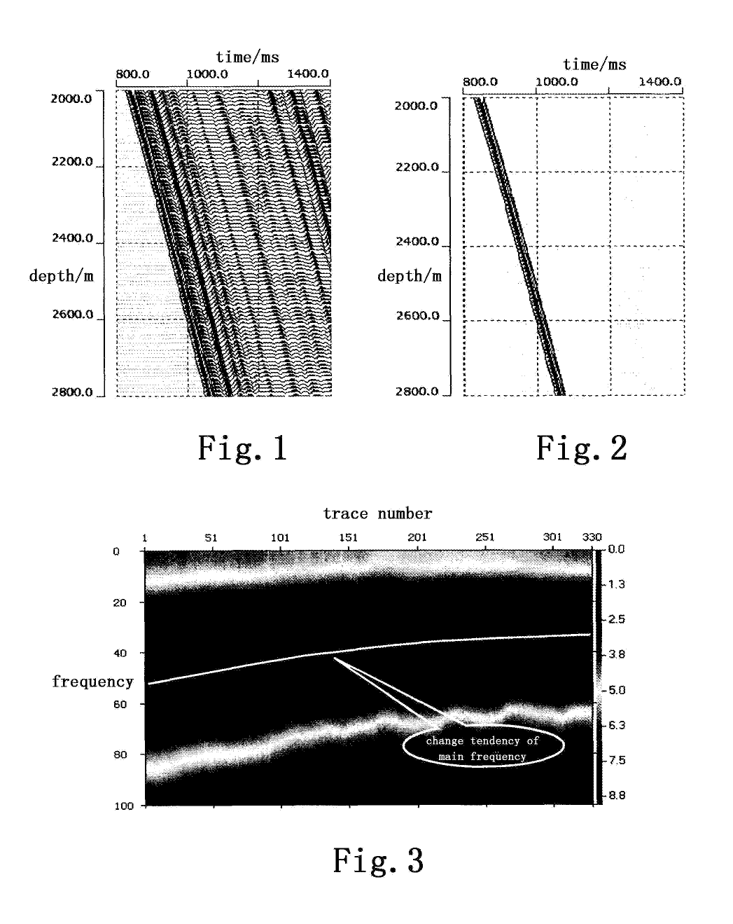

6) in the second wave field, applying Fourier transform to signal in a time window starting backwards from a first sampling point in each trace of the down going wave as shown in FIG. 1, so as to obtain a first amplitude spectrum on every frequency as shown in FIG. 2; and dividing the amplitude spectrum corresponding to every frequency by a square of a value of the corresponding frequency so as to obtain a second amplitude spectrum in an exponential form as shown in FIG. 3;

7) obtaining the second amplitude spectrum of every frequency in the exponential form in each trace of the down going wave by repeating the step 6);

8) obtaining first and second order coefficients corresponding to a trace of down going wavelet by taking a natural logarithm of the second amplitude spectrum of the trace obtained in the step 7) and then performing quadratic function fitting related to frequency by using a least square method;

9) obtaining the first and second order coefficients corresponding to each trace of the down going wavelet in the vertical seismic profile record by repeating the step 8);

10) picking up the first arrival 2 of the monitoring wavelet recorded in the step 1), obtaining a third amplitude spectrum of the monitoring wavelet on each frequency by applying Fourier transform to the monitoring wavelet signal corresponding to each trace of the vertical seismic profile record inside a time window starting backwards from the first arrival 2 of the monitoring wavelet signal; and obtaining a fourth amplitude spectrum of each trace of the monitoring wavelet in the exponential form by dividing the square of value of every frequency to the amplitude spectrum corresponding to the corresponding frequency;

11) obtaining first and second order coefficients of the frequency spectrum of a trace of the monitoring wavelet by taking a natural logarithm of the fourth amplitude spectrum obtained in the step 10) and then performing quadratic function fitting related to frequency by using the least square method;

12) obtaining the first and second coefficients corresponding to the monitoring wavelet corresponding to each trace of the vertical seismic profile record by repeating step 11);

13) solving, for each trace of the vertical seismic profile record, an average value between the second order coefficients of the trace and the second order coefficient of the corresponding monitoring wavelet obtained in step 12);

14) obtaining first and second coefficients by taking a natural logarithm of the second amplitude spectrum obtained in the step 7), subtracting a product of the average value of the second order coefficients of the seismic trace obtained in the step 13) and the square of the frequency, and then performing quadratic function fitting related to frequency by using the square method;

15) obtaining a first equivalent Q (strata quality factor) value by dividing the first order coefficient of each trace of the vertical seismic profile obtained in the step 14) to the first arrival time 1 of the trace;

16) obtaining the first equivalent strata quality factor of each trace of the vertical seismic profile record by repeating the step 15), and obtain a second equivalent Q (strata quality factor) value by performing statistic smoothing on the first equivalent strata quality factors of all traces of the vertical seismic profile record;

17) obtaining an absorption coefficient of each trace of the vertical seismic profile record by dividing the second equivalent Q (strata quality factor) value corresponding to the trace of the record to the first arrival time 1 of the trace;

18) obtaining an interval Q (strata quality factor) value corresponding to a trace of the vertical seismic profile record by dividing a difference value between the absorption coefficients of adjacent traces of the vertical seismic profile record to a difference value between the first arrival 1 of the adjacent traces;

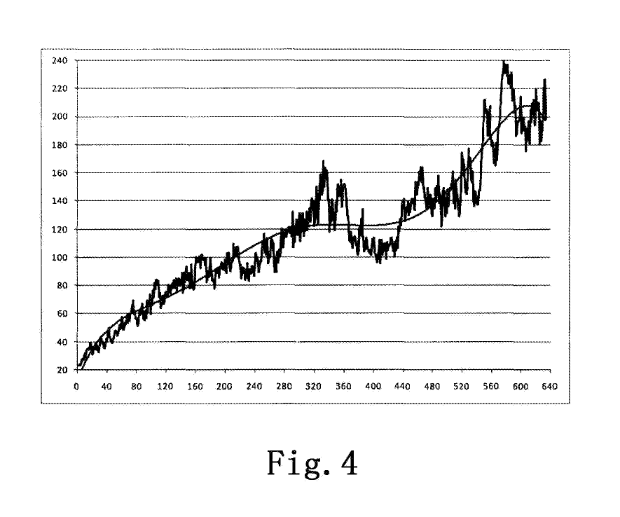

19) repeating the step 18), until the interval Q (strata quality factor) value corresponding to each trace of the vertical seismic profile record are inversed. As shown in FIG. 4, the interval Q increases with the increase of the depth.

### INDUSTRIAL APPLICABILITY

The present invention has a strong capability of resisting random disturbance, and is capable of removing a difference of the shocked wavelets. The algorithm is simple and may greatly save workload; moreover, the inverted Q value has desirable stability and high precision.

What is claimed is:

1. A strata quality factor inversion method, characterized in comprising:
1) shocking a surface seismic source, receiving vertical seismic profile data by geophone in underground, and receiving, by a geophone near the seismic source, a monitoring wavelet signal corresponding to each trace of vertical seismic profile record;
2) picking up a first arrival 1 of each trace of the vertical seismic profile record, and a first arrival 2 of the monitoring wavelet signal corresponding to each trace of the vertical seismic profile record;
3) flattening down going waves by subtracting the first arrival time 1 of each trace of the vertical seismic profile record from time of each sampling point of the said trace, so as to obtain a first wave field;
4) obtaining a frequency-wave number (F-K) spectrum of the first wave field by firstly applying Fourier transform to the first wave field in time direction so as to transform into frequency domain, thereby obtaining an amplitude spectrum of all of the vertical seismic profile record, and then applying Fourier transform to the amplitude spectrum in a direction of a trace number so as to transform into a wave number domain;
5) multiplying the frequency-wave number (F-K) spectrum corresponding to up going wave in the frequency-wave number (F-K) spectrum obtained in step (4) by zero; then performing an inverse Fourier transform in a direction of wave number to obtain an amplitude spectrum; applying an inverse Fourier transform in the frequency direction to the obtained amplitude spectrum so as to obtain a second wave filed in the time domain;
6) applying Fourier transform to signal in a time window starting backwards from a first sampling point in each trace of the down going wave in the second wave field, so as to obtain a first amplitude spectrum on every frequency; and dividing the amplitude spectrum corresponding to every frequency by a square of a value of the corresponding frequency so as to obtain a second amplitude spectrum in an exponential form;
7) obtaining the second amplitude spectrum of every frequency in the exponential form in each trace of the down going wave by repeating the step 6);
8) obtaining first and second order coefficients corresponding to a trace of down going wavelet by taking a natural logarithm of the second amplitude spectrum of the trace obtained in the step 7) and then performing quadratic function fitting related to frequency by using a least square method;
9) obtaining the first and second order coefficients corresponding to each trace of the down going wavelet in the vertical seismic profile record by repeating the step 8);
10) picking up the first arrival 2 of the monitoring wavelet recorded in the step 1), obtaining a third amplitude spectrum of the monitoring wavelet on each frequency by applying Fourier transform to the monitoring wavelet signal corresponding to each trace of the vertical seismic profile record inside a time window starting backwards from the first arrival 2 of the monitoring wavelet signal; and obtaining a fourth amplitude spectrum of each trace of the monitoring wavelet in the exponential form by dividing the square of value of every frequency to the amplitude spectrum corresponding to the corresponding frequency;
11) obtaining first and second order coefficients of the frequency spectrum of a trace of the monitoring wavelet by taking a natural logarithm of the fourth amplitude spectrum obtained in the step 10) and then performing quadratic function fitting related to frequency by using the least square method;
12) obtaining the first and second coefficients corresponding to the monitoring wavelet corresponding to each trace of the vertical seismic profile record by repeating step 11);
13) solving, for each trace of the vertical seismic profile record, an average value between the second order coefficients of the trace and the second order coefficient of the corresponding monitoring wavelet obtained in step 12);
14) obtaining first and second coefficients by taking a natural logarithm of the second amplitude spectrum obtained in the step 7), subtracting a product of the average value of the second order coefficients of the seismic trace obtained in the step 13) and the square of the frequency, and then performing quadratic function fitting related to frequency by using the square method;
15) obtaining a first equivalent strata quality factor value by dividing the first order coefficient of each trace of the vertical seismic profile obtained in the step 14) to the first arrival time 1 of the trace;
16) obtaining the first equivalent strata quality factor of each trace of the vertical seismic profile record by repeating the step 15), and obtain a second equivalent strata quality factor value by performing statistic smoothing on the first equivalent strata quality factors of all traces of the vertical seismic profile record;
17) obtaining an absorption coefficient of each trace of the vertical seismic profile record by dividing the second equivalent strata quality factor value corresponding to the trace of the record to the first arrival time 1 of the trace;
18) obtaining an interval strata quality factor value corresponding to a trace of the vertical seismic profile record by dividing a difference value between the absorption coefficients of adjacent traces of the vertical seismic profile record to a difference value between the first arrival 1 of the adjacent traces;
19) repeating the step 18), until the interval strata quality factor value corresponding to each trace of the vertical seismic profile record are inversed.
